(19) United States
(12) Patent Application Publication
(10) Pub. No.: US 2005/0061450 A1
(43) Pub. Date: Mar. 24, 2005

(54) Portable electronic dispenser for the application of labels

(75) Inventor: Nello Petitti, Anagni (FR) (IT)

Correspondence Address: YOUNG & THOMPSON, 745 SOUTH 23RD STREET, 2ND FLOOR, ARLINGTON, VA, 22202, US

(73) Assignee: OPEN DATA S.R.L., ANAGNI (FR) (IT)

(21) Appl. No.: 10/930,796

(22) Filed: Sep. 1, 2004

(30) Foreign Application Priority Data
Sep. 22, 2003 (IT) RM2003A000434

(51) Int. Cl. B32B 31/00; B44C 1/00

(52) U.S. Cl. 156/577; 156/350; 156/541

(57) ABSTRACT

A portable electronic dispenser for the application of labels includes elements for housing a tape-like support roll for labels and elements for unwinding the roll which cause a separation of the labels from the tape-like support, the unwinding elements including an assembly for driving the tape-like support formed by a driving roller, provided with actuating elements, and by contrast rollers spring loaded against the lateral surface of the driving roller, in which the elements for actuating the driving roller are constituted by a control system, having a gear motor inside the driving roller, a trigger for activation through an electronic board, an electric power supply and a photocell; the driving roller has on its lateral surface notched ring gears for engaging the tape-like support.

### BACKGROUND OF THE INVENTION

The present invention relates to a portable electronic dispenser for the application of labels on containers, packages or other items.

In general, current portable machines for the application of neutral or previously printed labels operate manually: the operator, pressing with the force of the hand on the grip of the machine causes the step by step unwinding of the roll that bears the labels and distributes said labels on the products to be labelled. This manual operation entails operator fatigue, time wastage and uncertainty in the correct distribution of the labels.

An existing motorised dispenser solves the aforementioned drawbacks of fatigue and time wastage, but not the one relating to the correct distribution of the labels. The known motorised dispenser has a system for advancing and driving the label bearer support based on the friction of two or more rollers made of rubber or other contrasting material. Since generally the label bearer support is a roll of silicone-coated paper, and thus quite slippery, this arrangement causes the rollers to slip on the silicone-coated paper, so that the proper advancement to obtain the correct application of the label may not be achieved.

### SUMMARY OF THE INVENTION

An essential object of the present invention, therefore, is to overcome the drawbacks of the prior art.

In particular, an object of the present invention is to provide a dispenser that allows a sure drive of the label bearer tape-like support.

Another object of the present invention is to provide a dispenser that eliminates operator fatigue in the application of the labels.

Another object of the present invention is to provide a dispenser that reduces the time required for applying labels of any format or size.

Yet another object of the present invention is to provide a dispenser that has a simple and reliable operation and an elementary maintenance.

Therefore, the present invention provides a portable electronic dispenser for the application of labels formed by a body provided posteriorly with a handle, the body superiorly bearing means for housing a silicone-coated tape-like support label bearing roller and means for unwinding the roll which determine a separation of the labels from the silicone coated tape-like support, the labels exiting, according to a first path from a front passage and the silicone coated tape-like support exiting, along a second path, from a rear opening, one and the other being obtained in a bottom positioned in the lower part of the body, and hinged therein in a pivot; the unwinding means comprising an assembly for driving the tape-like label bearer support formed by a driving roller, provided with actuating means, and by contrast rollers spring loaded against the lateral surface of the driving roller, which from a general viewpoint is characterized in that said means for actuating the driving roller are constituted by a control system, comprising a gear motor inside the driving roller, a trigger for activation through an electronic board, an electric power supply and a reflection photocell; said driving roller having on the lateral surface notched gear rings to assure the driving of the tape-like support.

### BRIEF DESCRIPTION OF THE DRAWINGS

Further characteristics and advantages of the present invention shall become more readily apparent from the detailed description that follows of a preferred embodiment illustrated purely by way of non limiting indication in the accompanying drawings in which:

FIG. 1 shows a schematic lateral view of an electronic dispenser according to the invention;

FIG. 2 shows a plan view of the dispenser of FIG. 1;

FIGS. 3A, 3B and 3C show the dispenser of FIG. 1 without the cover, the better to highlight the internal part, the cover itself and, respectively, a bottom; and

FIG. 4 shows a perspective bottom view of the dispenser of FIG. 3A.

### DESCRIPTION OF THE PREFERRED EMBODIMENTS

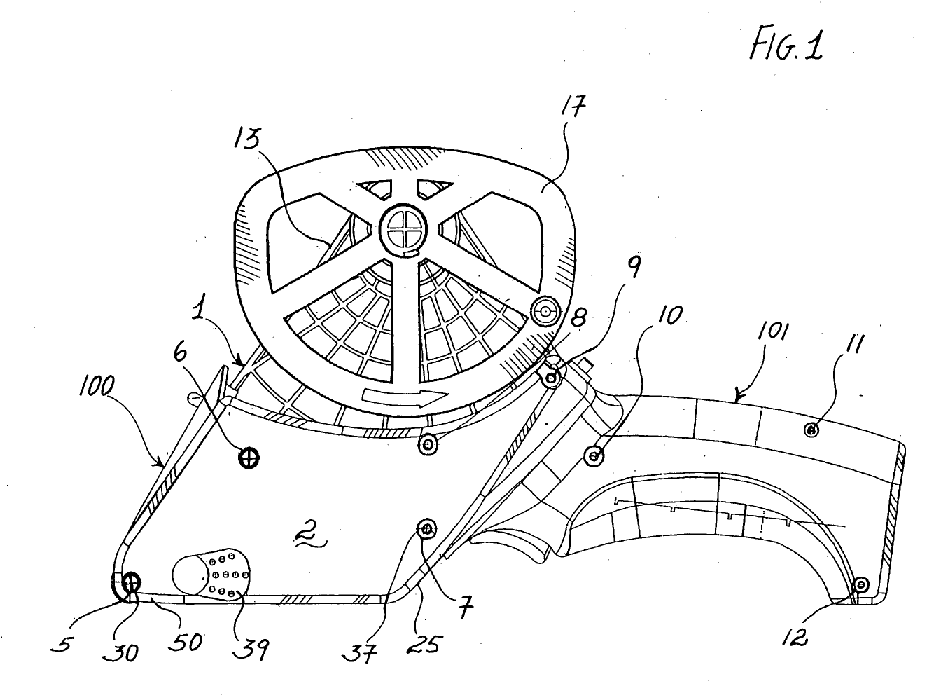

Referring initially to FIGS. 1, 2, 3A, 3B and 3C, which are lateral and plan views of the dispenser of the present invention, it has a plate base 1, a cover 2 and a bottom 3, openable in rotatable fashion. Moreover, anteriorly to the plate base 1 is mounted, also rotatable, a front openable cowling 4.

The plate base 1 serves as a support for the electromechanical and electronic parts of the dispenser, whilst the cover 2, the bottom 3 and the front cowling 4 serve, one as closure shell and the others as movable covering elements of the plate base 1. The overall configuration deriving from the whole as described above is that of a machine body 100 and of a handle 101 posterior to the body 100.

As shall be discussed in greater detail below, the body 100 is provided with means for housing a silicone coated tape-like label-bearing support roll with labels (not shown in the figures) and with means for unwinding the roller which cause a separation of the labels from the silicone coated tape-like support. The labels follow a path (not shown, as it is conventional) for application onto products according to a first direction, the support, deprived of the labels, advances to exit, according to a path in another direction (also not shown).

The plate base 1 and the cover 2 are mutually joined by means of screws or fastening pins, with the aid, when necessary, of spacers. The screws and the pins project outside the cover 2 through respective through holes, obtained in the cover itself, and designated as 5, 6, 7, 8, 9, 10, 11 and 12.

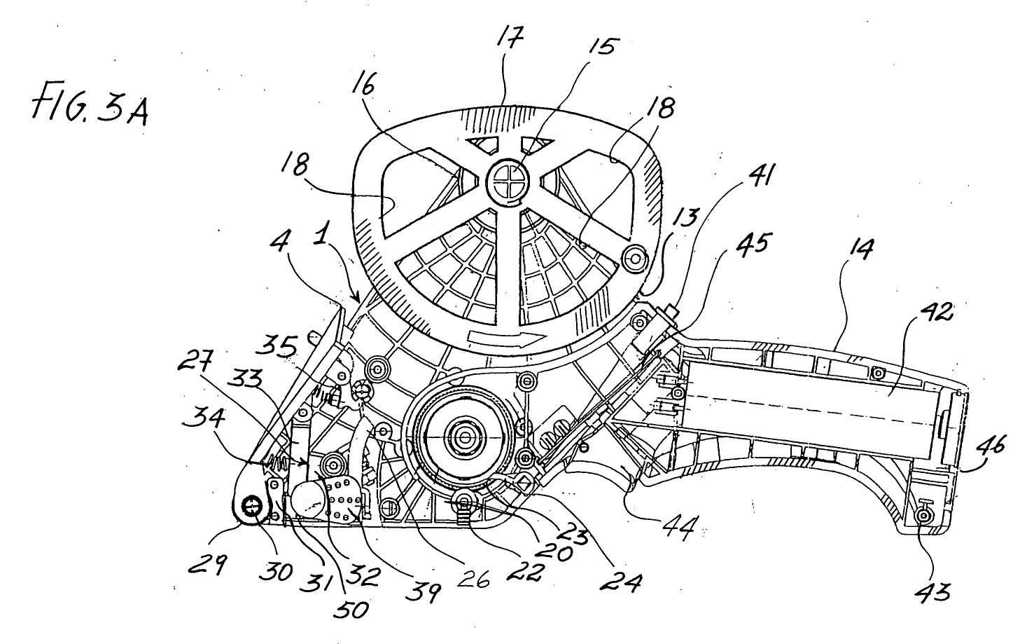

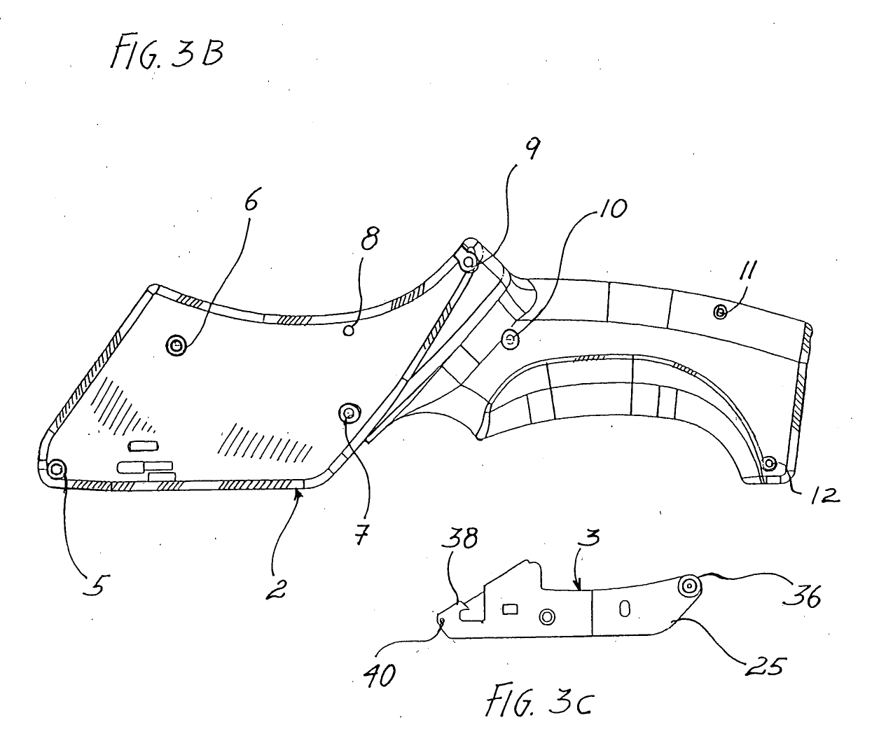

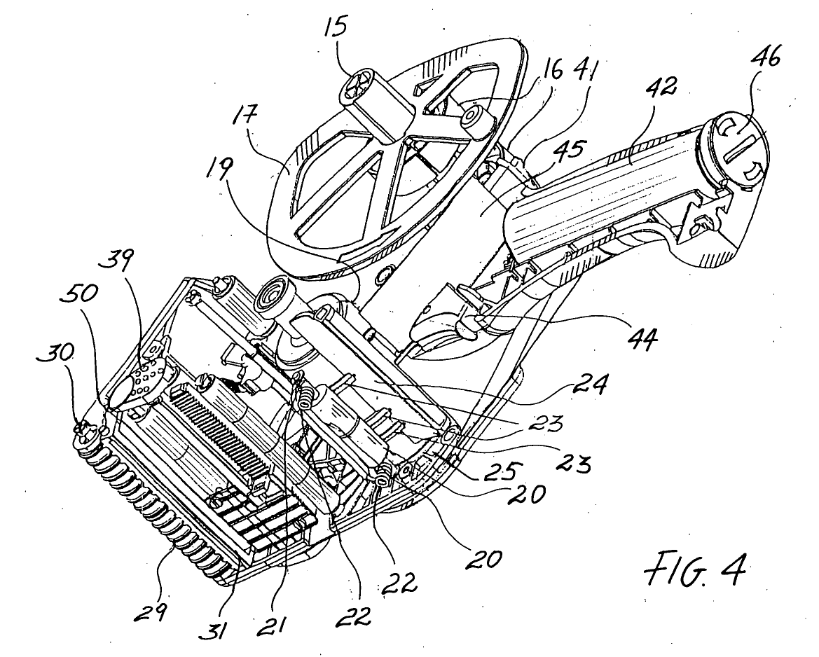

With reference to FIGS. 1 and 3A, which are respectively a complete lateral view of the dispenser and a view thereof without the cover 2, the plate base 1 is provided with a web of stiffening ribs. The plate base 1 comprises a body portion 13 with quadrilateral profile and a handle portion 14 shaped as a concave semi-grip.

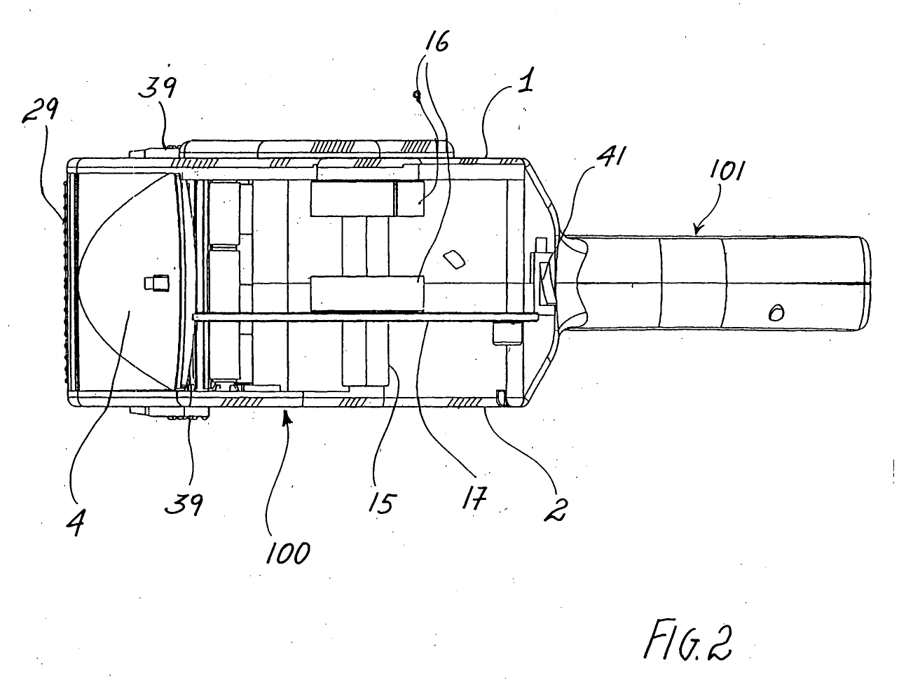

The body portion 13 superiorly has a triangular area to receive a roll formed by a label-bearing tape-like support as mentioned previously. As shown also in FIGS. 2 and 4, which are a top plan view of the dispenser of FIG. 1 and a perspective bottom view of the dispenser of FIG. 3A, the aforesaid means for housing the label-bearing roll comprise a support pivot 15, having an end passing in a hole on the triangular area of the body portion 13. On the support pivot 15 are rotatable roll-bearing drums 16. At the free end of the support pivot 15, opposite to the plate base 1, whereon it is fastened, is coaxially inserted a wall 17, lightened by circular sector slots 18. The wall 17 is movable along the support pin 15 to delimit laterally a label bearing roll. The position of the wall 17 on the support pin 15 depends on the width of the roll and hence on the size of the labels.

On the plate base 1, inferiorly to the support pin 15, are mounted the means for unwinding the silicone coated label-bearing tape-like support. Said means are mainly constituted by a driving roller 19 provided with an internal gear motor, and by contrasting rollers 20, 20 which engage the driving roller 19. The driving roller 19 is mounted at its ends on ball bearings. The contrasting rollers 20, 20, made of nylon or other suitable material, are mounted rotatably on an axle 21 loaded by springs 22, 22 so that the contrasting rollers 20, 20 are permanently in contact with notched gear rings 23, 23, 23 provided on the lateral surface of the driving roller, such as to assure the driving of the silicone-coated tape-like support. a curved guide element 24 for the tape-like support is fastened perpendicularly to the plate base 1 in such a way as to guide the silicone-coated tape-like support without labels towards a passage 25 obtained in the bottom 3.

Anteriorly to the driving roller 19 of the silicone-coated tape-like support is situated a curved profile 26 for guiding the label and an assembly 27 for braking said labels.

In the bottom 3 is anteriorly obtained a passage 50. On the front end of the plate base 1 is mounted, around a support pin 30 projecting through the hole 5 of the cover, a pressure roller 29 of the adhesive labels. The pressure roller 29 has a profile with projections, useful to fix the labels to the products. The profile with projections of the roller 29 is engaged by a block 31 for guiding the label in such a way as to allow the labels to pass correctly under the pressure roller 29 after exiting the brake assembly 27. The brake assembly 27 is constituted by two surfaces in contact, through which the labels pass before exiting the machine. The first surface belongs to a fixed block 32 of the brake assembly 27, whilst the second surface belongs to a braking element 33 hinged at one end to the front cowling 4 and loaded by a spring 34.

The front cowling 4 is hinged on the pivot 30, passing into the hole 5 of the cover 2, and it is provided on its internal side, i.e. on the same side whereon is hinged the braking element 33, with a hook element 35, spring loaded, and destined to engage a profile correspondingly provided in a rod positioned parallel to the pivots and the fastening screws of the dispenser.

In the lower part of the dispenser is mounted the bottom 3 with its rear end 36 (FIG. 3C) hinged in a pivot 37 (FIG. 1) passing in the hole 7 of the cover. Anteriorly, the bottom 3 is shaped as a hook 38 destined to be hitched in releasable manner by means of grip elements 39. In the front end of the bottom is also provided the photocell 40, which is part of the control system for operating the dispenser. Anteriorly to the photocell 40 is the passage 50 for the labels to be applied.

The rest of this control system is provided in the rear area of the body portion 13 and in the handle portion 14. As shown in FIGS. 3A and 4, the control system comprises a switch 41 and a trigger 44, in addition to a control board 45. The system is powered by a battery 42, positioned inside the handle, where it is closed with a plug 46. The battery can be rechargeable by means of a connector 43.

The path of the silicone-coated tape-like label-bearing support roll is started on the driving roller and held by the contrasting roller. While the tape-like support rotates on the surface of the driving roller 19, the labels are separated from the tape-like support and are made to advance on the curved profile 26 to pass through the brake assembly 27. The silicone-coated tape-like support without labels exits the cover 3, posteriorly, through the opening 25, whilst the labels, downstream of the brake assembly 27 exit the passage 50 anteriorly to the photocell 40.

The operation of the electronic dispenser is as follows. Once the switch 41 is closed, the driving roller 19 is made to rotate in stepped fashion by operating the trigger 44. The electronic board 45 operates as a control unit for the mode of application of the labels, which is regulated by the reflection photocell 40 positioned on the bottom 3. The labels are fed thanks to the advancement of the driving roller 19 moved by its internal gear motor.

In conclusion, the advantages of the dispenser of the present invention can be described.

Thanks to the ergonomic conformation of the body and of the handle, the handle follows the profile of the hand and the grip provides the proper balance to the whole machine, even when it is loaded with a new label bearing roll. Relative to traditional manual dispensers, operator fatigue is very much reduced, because the operator does not have to squeeze the dispenser in pincer fashion, but simply press the trigger. In this way, the gear motor of the driving roller is energized through the electronic board.

The label is applied in precise fashion, although they are provided on their silicone-coated tape-like support in irregular fashion. The paper support is driven by the driving roller by means of the notched gear rings present on its lateral surface. Their notches, aided by the contrasting rollers, engage the silicone-coated tape-like support, even if said support has variable thickness or more or less silicone is present on its faces.

Although the label has variable shapes and sizes, the positioning of the label is always correct, because its complete passage is revealed by the photocell.

The speed of application of the labels is high, because the labels are distributed with a motorised system controlled by an electronic unit represented by the board.

1. A portable electronic dispenser for the application of labels, formed by a body provided posteriorly with a handle, the body superiorly bearing means for housing a silicone-coated tape-like label-bearing support roll and means for unwinding the roll which cause a separation of the labels from the silicone-coated tape-like support, the labels exiting, according to a first front passage, and the silicone-coated tape-like support exiting, along a second path, from a rear opening, one and the other being obtained in a bottom positioned in the lower part of the body, and hinged therein; the unwinding means comprising an assembly for driving the label-bearing tape-like support formed by a driving roller, provided with operating means, and by contrasting rollers spring loaded against the lateral surface of the driving roller, wherein:
the means for operating the driving assembly are constituted by a control system, comprising a gear motor inside the driving roller, a trigger for activation through an electronic board, an electrical power supply and a reflection photocell; said driving roller having on its lateral surface notched gear rings such as to assure the driving of the tape-like support.

2. Electronic dispenser, as claimed in claim 1, wherein
said electrical power supply is a battery mounted in the handle.

3. Electronic dispenser as claimed in claim 1, wherein said reflection photocell is located anteriorly in the bottom facing the passage of the labels to be applied.

4. Electronic dispenser as claimed in claim 1, wherein said first path of advance of the labels comprises a brake assembly, including a block and a brake element on whose opposite surfaces pass, braked, the labels to be applied; the brake element being hinged to a front cowling of the body and spring loaded thereon.

5. Electronic dispenser as claimed in claim 1, wherein said body is formed by a plate base, by a cover, by an openable bottom and by an openable front cowling.

6. Electronic dispenser as claimed in claim 5, wherein the plate base of quadrilateral shape extending upwards as a triangle has said means for housing a roll in the form of a support pivot with roll-bearing drums and a wall, movable along the support pivot to delimit laterally a label-bearing roll.

7. Electronic dispenser as claimed in claim 6, wherein said wall is lightened with slots.
